(19) United States
(12) Patent Application Publication
(10) Pub. No.: US 2020/0052507 A1
(43) Pub. Date: Feb. 13, 2020

(54) CHARGING DEVICE FOR ELECTRIC VEHICLES

(71) Applicant: ABB Schweiz AG, Baden (CH)

(72) Inventors: Oscar Apeldoorn, Lengnau (CH); Osman Senturk, Den Haag (NL)

(21) Appl. No.: 16/659,114

(22) Filed: Oct. 21, 2019

Related U.S. Application Data
(63) Continuation of application No. PCT/EP2018/059876, filed on Apr. 18, 2018.

(30) Foreign Application Priority Data
Apr. 20, 2017 (EP) 17167217.3

(51) Int. Cl. H02J 7/00; B60L 53/10; B60L 53/14; B60L 53/67; B60L 55/00

(52) U.S. Cl. CPC H02J 7/0027; B60L 53/11; B60L 55/00; B60L 53/67; B60L 53/14

(57) ABSTRACT

The invention relates to a charging device for electric vehicles, including: a plurality of charging connections, of which each charging connection is configured for exchanging power with at least one electric vehicle; a plurality of current converters, of which each current converter is configured for converting power from a power source to a suitable format for charging the electric vehicle with direct current; and, a switchable connection matrix that is configured for connecting at least one current converter to at least one charging connection by means of at least one circuit breaker for providing a maximum rated current I_{N} at the charging connection, a plurality of high voltage contactor switches, wherein in addition to the connection matrix, at least one of the high voltage contactor switches is arranged between each current converter and each charging connection in the relevant direct current path, and each high voltage contactor switch is configured for switching a maximum current I_{MAX}>3*I_{N}; and, having a current converter housing within which all the current converters, the connection matrix, and all the high voltage contactor switches are arranged.

### TECHNICAL FIELD

The invention relates to a charging device for electric vehicles comprising a plurality of charging connections, of which each charging connection is configured for exchanging power with at least one electric vehicle; a plurality of current converters, of which each current converter is configured for converting power from a power source to a suitable format for charging the electric vehicle; and, a switchable connection matrix that is configured for connecting at least one current converter to at least one charging connection.

### TECHNOLOGICAL BACKGROUND

Charging devices for electric vehicles are known from the prior art and are also called electric charging points, charging columns, or charging points. A charging device frequently has a plurality of charging connections that, in the simplest case, are embodied as an outlet and into which a charging cable may be inserted for “filling up” an electric vehicle or have such a charging cable for connecting to the electric vehicle. According to the disseminated IEC 6185-1 standard, the charging cable may be securely connected to the electric vehicle, provided with a plug-in connector at both ends, or may be securely connected to the charging connection. In Europe, plug-in connectors for connecting the charging cable are frequently configured according to the IEC 62196 standard, for example as a so-called Combo 2 plug or as a coupling for direct current charging with up to 240 kW at 200-600 V DC voltage and up to 400 A direct current. Moreover, there are other standards for plug-in connectors, for example the CHAdeMO standard used in Japan or the SAE J1772 standard used in North America. High voltage contactor switches are provided in the charging connections, for example according to ISO 6469-3, in order to turn the direct current for charging the electric vehicle on and off.

In the aforesaid charging devices, the charging connections are frequently arranged physically distant from the current converters and a switchable connection matrix. While the current converters and the switchable connection matrix are arranged within a current converter housing on the edge of a parking lot, as a rule each charging connection is assigned to a parking space in the parking lot and is installed directly at that parking space. In large installations, the distance between the charging connections and the current converters and switchable connection matrix may be more than ten meters, or even a hundred meters.

While the advantage of the connection matrix is that a plurality of current converters for charging a single electrical vehicle are switched in parallel in order thereby to increase the available charging power and correspondingly shorten the charging period, one disadvantage of the configuration described in the foregoing is that the power may be available at the charging connection even when no electric vehicle is connected to the charging connection. Although under normal operating conditions this is not a problem, situations can nevertheless occur (for example due to damage to the charging connection or to the high voltage contactor switch in the charging connection as a result of vandalization or an accident caused by the electric vehicle) in which the power on the unused charging connection is a hazard, for example a short circuit or arcing, or may even cause the charging connection to be destroyed.

### SUMMARY OF THE INVENTION

Proceeding from this situation, it is an object of the invention to provide a charging device for electric vehicles that is characterized by improved operational reliability.

The object is attained using the features of the independent claim. Advantageous embodiments are provided in the subordinate claims.

Consequently, the object is attained by a charging device for electric vehicles comprising: a plurality of charging connections, of which each charging connection is configured for exchanging power with at least one electric vehicle; a plurality of current converters, of which each current converter is configured for converting power from a power source into a suitable format for charging the electric vehicle with direct current; and, a switchable connection matrix that is configured for connecting at least one current converter to at least one charging connection by means of at least one circuit breaker for providing a maximum rated current I_{N} at the charging connection; a plurality of high voltage contactor switches, wherein, in addition to the connection matrix, at least one of the high voltage contactor switches is arranged between each current converter and each charging connection in the relevant direct current path, and each high voltage contactor switch is configured for switching a maximum current I_{MAX}>3*I_{N}; and having a current converter housing within which all the current converters, the connection matrix, and all the high voltage contactor switches are arranged.

One significant aspect of the invention is thus that the high voltage contactor switch is not arranged at the charging connection assigned thereto, provided for example within a housing of the charging connection, but instead is arranged physically distant from the charging connection within the current converter housing, for example within a housing of the connection matrix. The specific charging connection is not supplied with electrical energy for charging the electric vehicle with direct current until the high voltage contactor switch is turned on. If the high voltage contactor switch arranged in the specific current path is turned off, the corresponding charging connection is not supplied with electrical energy and is not supplied with direct current. In other words, the charging connection, including the electrical connection between connection matrix and charging connection, especially if there is no electric vehicle to charge, may be switched in a currentless manner by turning off the high voltage contactor switch.

Compared to charging devices known from the prior art, in which the high voltage contactor switch is arranged within the charging connection and therefore the charging connection is supplied with electrical energy even when no electric vehicle is connected, due to the suggested charging device it is assured that, when the high voltage contactor switch is turned off, a short circuit occurring in the charging connection or some other mechanical damage to the charging connection, for example due to an accident of the electric vehicle, does not lead to arcing or some other hazard to life or the electric vehicle. Accordingly, the probability of failure of the suggested charging device is significantly lower compared to solutions known from the prior art.

Since the high voltage contactor switch for switching the direct current is not arranged in the charging connection, the charging connection may be embodied much more compact, because, compared to charging connections known from the prior art, in which high voltage contactor switches arranged therein need devices for cooling and in some cases air conditioning, such items are no longer required for the suggested charging connections because, compared thereto the high voltage contactor switches within the current converter housing is provided, for example, within the connection matrix or between the current converter and the connection matrix. Correspondingly, the concept should also be understood such that, in addition to the high voltage contactor switches frequently provided in the connection matrix, for a given operation of the connection matrix a plurality of other high voltage contactor switches are provided in the specific current path. In the prior art, these additional high voltage contactor switches were provided within the charging connections, instead.

In principle there are various options for embodying the charging connections. The charging connections are preferably provided with a cable, the one end of which is securely connected to the charging connection, and the other end of which is embodied with a charging plug for connecting to the electric vehicle. The charging connections are preferably embodied according to the EN 62196 standard and have, for example, a charging coupling according to the Type 2 standard, also known as a Mennekes plug, in order to supply the electric vehicle with direct current. An electric vehicle may in principle be any vehicle driven with an electric motor, even an electric bus, for example, wherein a battery provided in the electric vehicle is charged by electrical power from the charging connection.

The current converters are preferably embodied as rectifiers known from the prior art and each permit conversion of 150, 300, and 450 kW, for example. Current converters (Stromrichter) are also called power converters (Leistungsumsetzer). On the direct current side, the current converters are connected to the connection matrix, either via a direct cable connection or via the high voltage contactor switch according to the second alternative of charging device described in the foregoing. In this case, a high voltage contactor switch is preferably provided between each current converter and the connection matrix. On the alternate current side, the current converter is preferably connected to an alternating current power supply via a transformer. The high voltage contactor switches are preferably embodied such that an interruption in the current path or separation of a charging connection from the current converters is always provided “safely”, without arcing or the like occurring during the interruption. The high voltage contactor switches are preferably embodied according to ISO 6469-3 and/or designed for load voltages of a maximum of 500 V_{DC} for passenger cars and a maximum of 900 V_{DC} for trucks. It is furthermore preferred that each high voltage contactor switch is designed for switching a maximum current I_{MAX}>4, 5 or 6*I_{N}.

According to one preferred refinement, one of the high voltage contactor switches is arranged between the connection matrix and each charging connection, between each current converter and the connection matrix, and/or within the connection matrix between at least one current converter and each charging connection. The current converter housing is made, for example, of plastic, metal, stone, concrete, a mixture of the aforesaid materials, and/or is embodied in a weather-resistant manner, so that the current converter housing may be installed, for example, at a parking lot for electric vehicles. The current converter housing is preferably embodied as a closed housing, the current converters, connection matrix, and high voltage contactor switches being arranged in the interior thereof. The housing may be provided with a lockable door and/or opening.

According to one alternative preferred refinement, the charging device has a connection matrix housing, wherein the connection matrix is arranged within the connection matrix housing and one of the high voltage connector switches is arranged between each charging connection and at least one current converter. The connection matrix housing may be embodied analogous to the current converter housing described in the foregoing, for example it may be embodied by a closed housing made of a plastic or the like, the connection matrix and the high voltage contactor switches being arranged in the interior thereof.

According to another preferred alternative embodiment, the charging device has a connection matrix housing, wherein the connection matrix housing is arranged within the current converter housing and the connection matrix is arranged within the connection matrix housing and is arranged between each charging connection and the connection matrix. According to this embodiment, the connection matrix is arranged within the connection matrix housing, which itself is provided within the current converter housing. The connection matrix housing is preferably embodied as previously, for example like a transformer housing or a part thereof.

According to one preferred refinement of the invention, all high voltage contactor switches are arranged at a location distant from the charging connections and/or at least 5, 10, or 20 meters from one another. The separate location may a separate space, for example, or a separate building. Likewise, the high voltage contactor switches may be arranged, as described in the foregoing, within the connection matrix or between the connection matrix and the current converters in a separate space, for example on the edge of a parking lot, while the charging connections may be arranged immediately at the individual parking spaces of the parking lot. More preferably, the high voltage contactor switches are arranged at least 50, 100, or 150 meters distant from the charging connections. Even more preferably, the charging connections are configured without high voltage contactor switches and/or are embodied such that an exchange of power with the electric vehicle is possible without switching a high voltage contactor switch arranged in the charging connection.

According to another preferred embodiment, the charging device has a plurality of connecting cables having a length of at least 5, 10, or 20 meters, wherein a connecting cable for exchanging power with the electric vehicle is provided between each charging connection and the connection matrix. The connecting cable preferably is at least 50, 100, or 150 meters in length, wherein the length may also be longer. The connecting cable is preferably installed securely between the charging connection and the connection matrix, for example within the ground area of a parking lot where the charging device is installed.

In principle the connection matrix may be embodied in a wide variety of ways. According to one preferred refinement, the connection matrix is configured for connecting at least two current converters to one charging connection or for simultaneously connecting at least one current converter to at least one charging connection and at least one other current converter to one other charging connection such that the one charging connection is not connected to the other charging connection and/or connecting the at least one current converter to the at least one charging connection may be controlled by the connection matrix using decision rules. The connection matrix is furthermore preferably embodied such that the charging connections and current converters connected to the connection matrix may be connected in different manners. Current may be distributed from at least one of the current converters to different or a plurality of charging connections by means of the connection matrix. Within the connection matrix, the electrical connection between at least one of the current converters, as input, and at least one of the charging connections, as output, may comprise a mechanical switch, solid state switch, circuit breaker, safety element, passive semiconductor, or a combination thereof.

The connection matrix preferably has a control unit in order to control operation of the connection matrix. More preferred, the connection matrix may be controlled using an input of a system connected via the internet, using the electric vehicle, and/or using a computer-implemented method. Given preferred use of the charging standard EN 62196 Type 2, a bidirectional communication channel may be provided between the electric vehicle and the charging device, by means of which communication channel, on the one hand, the charging device may read out the charging power supported by the electric vehicle, and/or, on the other hand, the electric vehicle may request a charging power from the charging device. The request may be implemented by the connection matrix by connecting a plurality of current converters, for example by switching different current converters in parallel, so that the power for charging the electric vehicle is correspondingly increased.

According to another preferred embodiment, the connection matrix has a plurality of semiconductor-based circuit breakers for connecting the at least one current converter to the at least one charging connection. The circuit breaker arranged within the connection matrix and/or between the connection matrix and the current converter is preferably also embodied as a semiconductor-based circuit breaker, for example an IGBT, as contactor, and/or for switching direct currents up to 350 A or 500 A.

According to one preferred refinement, the charging connection has a man-machine interface, a temperature control device configured for cooling and/or heating the charging connection, an input unit (central control), and/or an interface for monitoring the charging process (charge protocol interface, CPI). The man-machine interface is configured as an input/output device, for example. The temperature control device may be embodied as a kind of air conditioning system having water and/or air cooling. A temperature control device may also be provided within the previously described current converter housing and/or the connection matrix housing for cooling and/or heating the corresponding housing and may be connected to the temperature control device of the charging connection.

According to one preferred refinement, the charging device has a monitoring device, wherein the charging connection is configured to detect a charging error during exchange of power with the electric vehicle and to report the charging error to the monitoring device. In this context, according to one preferred refinement it is provided that at least one of the current converters, the connection matrix, and/or the monitoring device is configured to interrupt the exchange of power with the electric vehicle following detection of the charging error. The charging error may be, for example, a drop in voltage and/or current, a short circuit, or the like. The monitoring device is preferably embodied by a computer-based control unit and/or is operatively connected to the high voltage contactor switch. Correspondingly, the exchange of power with the electric vehicle may be interrupted by turning off the high voltage contactor switch or by separating the affected current converter from the power source.

According to another preferred embodiment, in this context it is provided that the monitoring device is configured to detect a conversion error on the current converters and to turn off the current converter causing the conversion error following detection of the conversion error. Furthermore, the monitoring device is preferably embodied to connect a different current converter to the charging connection following detection of the conversion error, so that the electric vehicle may continue to be charged without interruption. The high voltage contactor switch causing the conversion error may be turned off by turning off the high voltage contactor switch correspondingly connected to the current converter. The exchange of power with the electric vehicle may furthermore be interrupted by removing a charging plug from the charging connection, for example, by discarding the charging plug.

### BRIEF DESCRIPTION OF THE DRAWINGS

The invention is explained in greater detail in the following, referencing the attached drawings and using preferred embodiments.

The figures are as follows:

FIG. 1 is a schematic elevation of a charging device for electric vehicles according to a first preferred exemplary embodiment;

FIG. 2 is a schematic elevation of the charging device for electric vehicles according to another preferred exemplary embodiment of the invention; and,

FIG. 3 is a schematic elevation of the charging device for electric vehicles according to another preferred exemplary embodiment of the invention.

### DESCRIPTION OF THE EXEMPLARY EMBODIMENTS

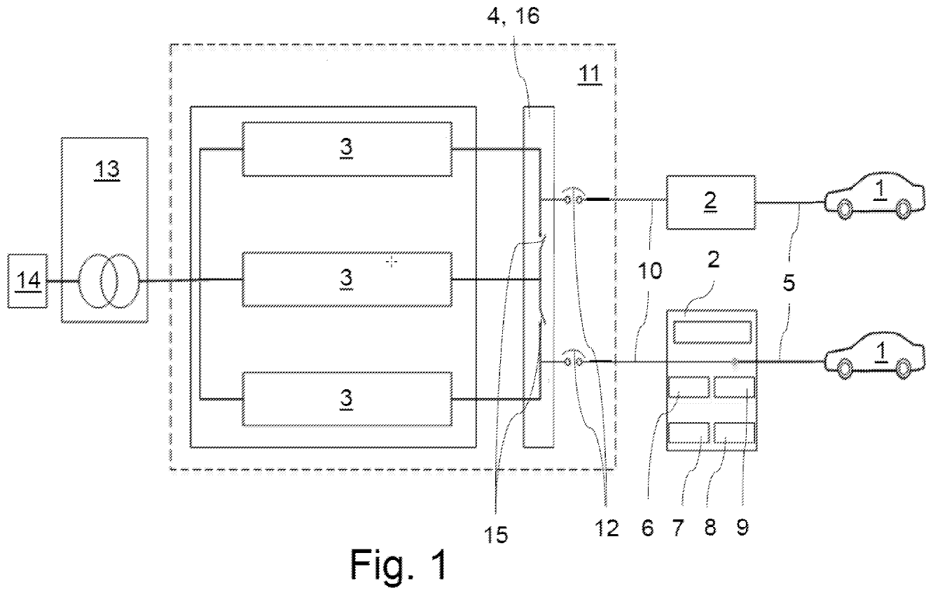

FIGS. 1 through 3 each provide a schematic elevation of a charging device for electric vehicles 1 according to preferred embodiments of the invention. The charging device has a plurality of charging connections 2, a plurality of current converters 3, and a switchable connection matrix 4. The charging connections 2 are each configured for exchanging power with an electric vehicle 1 that is electrically connected to the charging connection 2 by means of a connecting cable 5.

The charging connections 2 are each embodied for direct current charging according to the standard IEC 62196, wherein the charging cable 5 is connected at its one end to the specific charging connection 2 and at its other end has a plug-in connector according to the aforesaid standard. Correspondingly, a corresponding charging socket or coupling is provided on the electric vehicle 1 and the plug-in connector of the charging cable 5 may be inserted therein. Each charging connection 2 has different operating elements, for example a man-machine interface 6 with a display and input device, a temperature control device 7 by means of which the charging connection 2 may be cooled and heated, and an input unit 8 (central control), and an interface for monitoring the charging process 9 (Charge Protocol Interface, CPI).

The charging connections 2 are each arranged at least physically 20 meters distant from the connection matrix 4 and are electrically connected to the connection matrix 4 by means of a connecting cable 10, which correspondingly is likewise at least 20 meters in length. Like the charging cable 5, the connecting cable 10 is embodied for exchanging electrical power.

While the charging connections 2 are arranged at a parking space in a parking lot in the immediate vicinity of the specific electric vehicle 1, a current converter housing 11, within which all current converters 3, the connection matrix 4, and all high voltage contactor switches 12 are arranged, is arranged on one edge of the parking lot. The current converter housing 11 is embodied of a plastic with a metal portion, in a weather-resistant manner, and is installed at least 20 meters distant from the parking spaces.

The current converters 3 are embodied as rectifiers and on the direct current side are connected to the connection matrix 4. On the alternating current side, the current converters 3 are interconnected with a secondary side of a transformer 13. On the primary side, the transformer is attached to an electrical power system as the power source 14. In this way each current converter 3 converts electrical power provided by the power source 14 to a suitable format for charging the electric vehicle 1 with direct current.

The connection matrix 4 has a plurality of semiconductor-based circuit breakers 15 in order to connect at least one current converter 3 to at least one charging connection 2. In addition, the connection matrix 4 may be controlled using decision rules. In the configuration illustrated in FIG. 1, all three current converters 3 may be switched in parallel by closing the two semiconductor-based circuit breakers 15. If each current converter 3 can convert an electrical power of 150 kW, in this case it would be possible to charge a single electric vehicle 1 with 450 kW. According to the specific configuration illustrated in FIG. 1, with unclosed semiconductor-based circuit breakers 15, on the one hand the electric vehicle 1 illustrated at the top may be charged with electrical power that can be provided by the current converter 3 shown at the top, and on the other hand, parallel thereto, the electric vehicle 1 illustrated at the bottom may be charged with electrical power provided by the current converter 3 illustrated at the bottom.

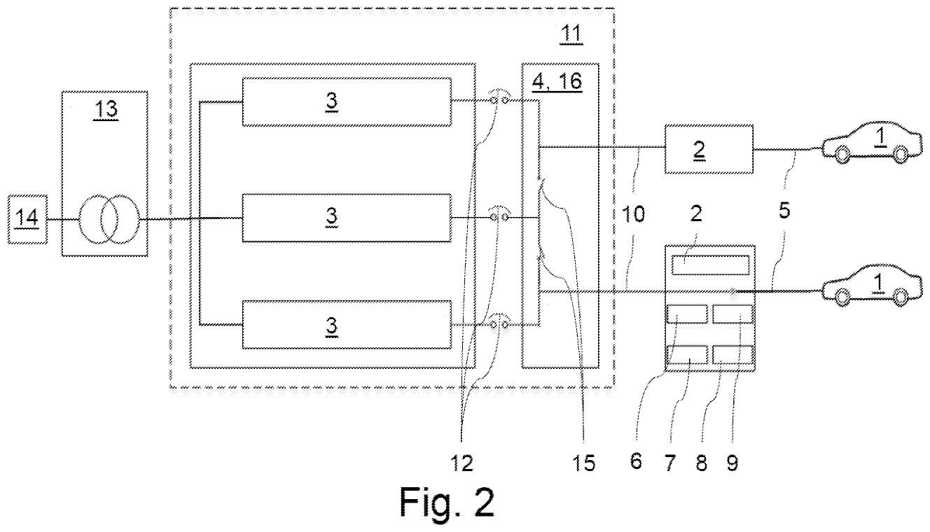

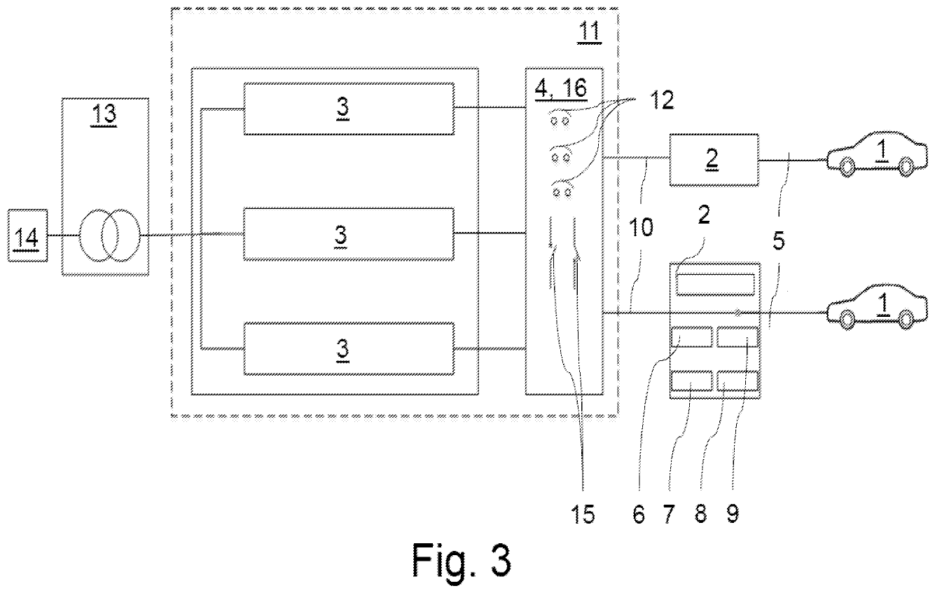

Compared to charging devices known from the prior art, in which the high voltage contactor switches 12 for switching the electrical power required for charging the electric vehicle are arranged within the charging connection 2, the described charging device is distinguished in that no high voltage contactor switch 12 is arranged in the charging connection 2, at least not for switching the electrical power for charging the electric vehicle 1. The high voltage contactor switches 12 are illustrated within the current converter housing 11, as illustrated in FIGS. 1 and 2, or within a connection matrix housing 16, as illustrated in FIG. 3, between the current converters 3 and the charging connections 2. The connection matrix 4, the current converter housing 11, and the high voltage contactor switches 12 are shown as closed parts in the figures; the parts may also be combined, however, either entirely or in part.

The connection matrix 4 is arranged within the closed connection matrix housing 16, which, together with the current converters 3, is arranged within the current converter housing 11. As already stated, in the embodiment illustrated in FIG. 1 all high voltage contactor switches 12 are arranged within the connection matrix housing 16, wherein one high voltage contactor switch 12 is arranged between each charging connection 2 and the semiconductor-based circuit breakers 15 of the connection matrix 3. The high voltage contactor switches 12 are thus arranged both within the current converter housing 11 and within the connection matrix housing 16 on the output side on the connection matrix 4.

In contrast, in the embodiment illustrated in FIG. 2, the high voltage contactor switches 12 are arranged between each current converter 3 and the connection matrix 4. The high voltage contactor switches 12 are provided outside of the connection matrix housing 16, but within the current converter housing 11.

The embodiment illustrated in FIG. 3 illustrates a combination of high voltage contactor switches 12 with the semiconductor-based circuit breakers of the connection matrix 4, which however are arranged entirely within the connection matrix 4, within the connection matrix housing 16, and also within the current converter housing 11.

The suggested charging device ensures that when the high voltage contactor switch 12 is turned off, a short circuit occurring in the charging connection 2 or some other mechanical damage to the charging connection 2, for instance due to an accident by the electric vehicle 1, does not lead to arcing or to some other hazard to life or to the electric vehicle 1. Correspondingly, the probability of failure of the suggested charging device is significantly lower compared to solutions known from the prior art.

### REFERENCE LIST

1 Electric vehicle

2 Charging connection

3 Current converter

4 Connection matrix

5 Charging cable

6 Man-machine interface

7 Temperature control device

8 Input unit (central control)

9 Interface for monitoring the charging process (charge protocol interface)

10 Connecting cable

11 Current converter housing

12 High voltage contacting switch

13 Transformer

14 Power source

15 Circuit breaker

16 Connection matrix housing

1. A charging device for electric vehicles, comprising:
a plurality of charging connections, of which each charging connection is configured for exchanging power with at least one electric vehicle;
a plurality of current converters, of which each current converter is configured for converting power from a power source to a suitable format for charging the electric vehicle with direct current;
a switchable connection matrix that is configured for connecting at least two current converters to at least one charging connection or for simultaneously connecting at least one current converter to at least one charging connection and at least one other current converter to one other charging connection such that the one charging connection is not connected to the other charging connection and/or wherein connecting the at least one current converter to the at least one charging connection may be controlled by the connection matrix using decision rules, in each case by means of at least one circuit breaker for providing a maximum rated current I_{N} at the charging connection;
a plurality of high voltage contactor switches, wherein in addition to the connection matrix, at least one of the high voltage contactor switches is arranged between each current converter and each charging connection in the relevant direct current path, and each high voltage contactor switch is configured for switching a maximum current I_{MAX}>3*I_{N}; and,
having a current converter housing that is arranged physically distant from the charging connections and within which all the current converters, the connection matrix, and all the high voltage contactor switches are arranged.

2. The charging device for electric vehicles according to claim 1, wherein one of the high voltage connector switches is arranged between the connection matrix and each charging connection, between each current converter and the connection matrix, and/or within the connection matrix between at least one current converter and each charging connection.

3. The charging device for electric vehicles according to claim 1, further comprising a connection matrix housing, wherein the connection matrix is arranged within the connection matrix housing and one of the high voltage connector switches is arranged between each charging connection and at least one current converter.

4. The charging device for electric vehicles according to claim 1, further comprising a connection matrix housing, wherein the connection matrix housing is arranged within the current converter housing and the connection matrix is arranged within the connection matrix housing and one of the high voltage contactor switches is arranged between each charging connection and the connection matrix.

5. The charging device for electric vehicles according to claim 1, wherein all high voltage contactor switches are arranged at a distance of at least 5 meters from the charging connections.

6. The charging device for electric vehicles according to claim 1, further comprising a plurality of connecting cables having a length of at least 5 meters, wherein a connecting cable is provided between each charging connection and the connection matrix.

7. (canceled)

8. The charging device for electric vehicles according to claim 1, wherein the connection matrix has a plurality of semiconductor-based-circuit breakers for connecting the at least one current converter to the at least one charging connection.

9. The charging device for electric vehicles according to claim 1, wherein the charging connection has a man-machine interface, a temperature control device configured for cooling and/or heating the charging connection, an input unit (Central Control), and/or an interface for monitoring the charging process (Charge Protocol Interface, CPI).

10. The charging device for electric vehicles according to claim 1, further comprising a monitoring device, wherein the charging connection configured to detect a charging error during exchange of power with the electric vehicle and to report the charging error to the monitoring device.

11. The charging device for electric vehicles according to claim 10, wherein at least one of the current converter, the connection matrix, and/or the monitoring device is configured to interrupt the exchange of power with the electric vehicle following detection of the charging error.

12. The charging device for electric vehicles according to claim 1, wherein the monitoring device is configured to detect an conversion error on the current converters and to turn off the current converter causing the conversion error following detection of the conversion error.

13. The charging device for electric vehicles according to claim 2 further comprising a connection matrix housing, wherein the connection matrix is arranged within the connection matrix housing and one of the high voltage connector switches is arranged between each charging connection and at least one current converter.

14. The charging device for electric vehicles according to claim 2, further comprising a connection matrix housing, wherein the connection matrix housing is arranged within the current converter housing and the connection matrix is arranged within the connection matrix housing and one of the high voltage contactor switches is arranged between each charging connection and the connection matrix.

15. The charging device for electric vehicles according to claim 1, wherein all high voltage contactor switches are arranged at a distance of at least 10 meters from the charging connections.

16. The charging device for electric vehicles according to claim 2, wherein all high voltage contactor switches are arranged at a distance of at least 5 meters from the charging connections.

17. The charging device for electric vehicles according to claim 1, further comprising a plurality of connecting cables having a length of at least 10 meters, wherein a connecting cable is provided between each charging connection and the connection matrix.

18. The charging device for electric vehicles according to claim 1, further comprising a plurality of connecting cables having a length of at least 5 meters, wherein a connecting cable is provided between each charging connection and the connection matrix.

19. The charging device for electric vehicles according to claim 2, wherein the connection matrix has a plurality of semiconductor-based-circuit breakers for connecting the at least one current converter to the at least one charging connection.

20. The charging device for electric vehicles according to claim 2, wherein the charging connection has a man-machine interface, a temperature control device configured for cooling and/or heating the charging connection, an input unit (Central Control), and/or an interface for monitoring the charging process (Charge Protocol Interface, CPI).

21. The charging device for electric vehicles according to claim 2, wherein the monitoring device is configured to detect an conversion error on the current converters and to turn off the current converter causing the conversion error following detection of the conversion error.
